(19) United States
(12) Patent Application Publication
(10) Pub. No.: US 2007/0058730 A1
(43) Pub. Date: Mar. 15, 2007

(54) Media stream error correction

(75) Inventors: Todd Bowra, Redmond, WA (US); Jeffrey Davis, Snohomish, WA (US); Gurpratap Virdi, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/222,692

(22) Filed: Sep. 9, 2005

(51) Int. Cl. H04B 1/66

(52) U.S. Cl. 375/240.28

(57) ABSTRACT

Defects and errors detected in media content supplied by a content source are corrected before the media content is delivered to a decoder. In one possible implementation, the detection and correction of defects and errors in the media content is conducted within a media stream analysis module. Correction of defects and errors may include the insertion, deletion or correction of headers, the insertion of broken link flags into the media content, the throttling of audio content in the media content versus video content in the media content, and the dropping of frames from the media content.

### BACKGROUND

As the personal computer (PC) moves to become the center of the digital home, more consumers will be able to enjoy the PC's functionality as an entertainment server. In one popular implementation, an entertainment server is able to receive media content from a content source, and stream the media content to a variety of home client devices. Often, however, the entertainment server has control over neither the quality of media content being offered by the content source, nor the robustness of the decoders in the home client devices being used to decode and render the streamed media content. Accordingly, even if the entertainment server performs perfectly, the overall quality of a playback experience may suffer if either the quality of the media content sent from the content source is poor, or if the quality of a decoder in a home client device is sub-par.

Thus, there exists a need to enable a PC to deliver the highest possible quality of media experience, in spite of the fact that the PC may receive poor quality media content from an outside content source, and the media content may be rendered by a low quality decoder.

### SUMMARY

Defects and errors detected in media content supplied by a content source are corrected before the media content is delivered to a decoder. In one possible implementation, the detection and correction of defects and errors in the media content is conducted within a media stream analysis module. Correction of defects and errors may include the insertion, deletion or correction of headers, the insertion of broken link flags into the media content, the throttling of audio content in the media content versus video content in the media content, and the dropping of frames from the media content.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an exemplary home environment including an entertainment server, a home network device, and a home television.

FIG. 2 shows an exemplary architecture for streaming media content from a content source to a home network device using a media stream analysis module.

FIG. 3 illustrates a block diagram of a media stream analysis module being used in conjunction with an entertainment server communicatively coupled to a home network device.

FIG. 4a illustrates a defect free stream of frames along with a stream of frames containing defects and/or errors which might be encountered by the media stream analysis module.

FIG. 4b illustrates a defect free series of Groups of Pictures (GOPs) along with a series of GOPs in which a discontinuity is adjacent to an open GOP.

FIG. 5 is a flow diagram illustrating a methodological implementation of a media stream analysis module to detect and correct defects and errors in media content.

FIG. 6 is a flow diagram illustrating a methodological implementation of a correction module to select and implement an action to cure a defect or error in media content.

### DETAILED DESCRIPTION

### Home Environment

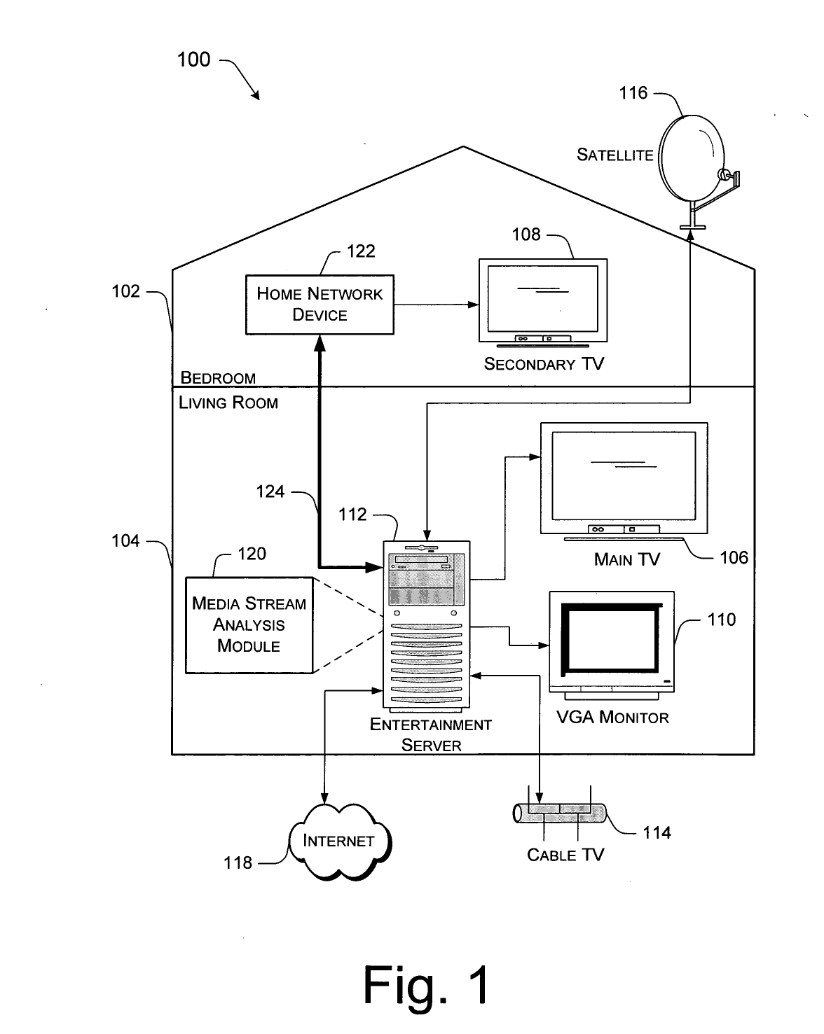

FIG. 1 shows an exemplary home environment 100 including a bedroom 102 and a living room 104. Situated throughout the home environment 100 are a plurality of monitors, such as a main TV 106, a secondary TV 108, and a VGA monitor 110. Content may be supplied to each of the monitors 106, 108, 110 over a home network from an entertainment server 112 situated in the living room 104. In one implementation, the entertainment server 112 is a conventional personal computer (PC) configured to run a multimedia software package like the Windows® XP Media Center edition operating system marketed by the Microsoft Corporation. In such a configuration, the entertainment server 112 is able to integrate full computing functionality with a complete home entertainment system into a single PC. For instance, a user can watch TV in one graphical window of one of the monitors 106, 108, 110 while sending email or working on a spreadsheet in another graphical window on the same monitor. In addition, the entertainment server 112 may also include other features, such as:
A Personal Video Recorder (PVR) to capture live TV shows for future viewing or to record the future broadcast of a single program or series.
DVD playback.
An integrated view of the user's recorded content, such as TV shows, songs, pictures, and home videos.
A 14-day EPG (Electronic Program Guide).

In addition to being a conventional PC, the entertainment server 112 may also comprise a variety of other devices capable of rendering a media component including, for example, a notebook or portable computer, a tablet PC, a workstation, a mainframe computer, a server, an Internet appliance, combinations thereof, and so on. It will also be understood, that the entertainment server 112 could be an entertainment device, such as a set-top box, capable of delivering media content to a computer where it may be streamed, or the entertainment device itself could stream the media content.

With the entertainment server 112, a user can watch and control a live stream of television or audio content received, for example, via cable 114, satellite 116, an antenna (not shown for the sake of graphic clarity), and/or a network such as the Internet 118. This capability is enabled by one or more tuners residing in the entertainment server 112. It will also be understood, however, that the one or more tuners may be located remote from the entertainment server 112 as well.

The entertainment server 112 may also receive media content from computer storage media such as a removable, non-volatile magnetic disk (e.g., a “floppy disk”), a non-volatile optical disk such as a CD-ROM, DVD-ROM, or other optical media, as well as other storage devices which may be coupled to the entertainment server 112, including devices such as digital video cameras.

Multi-channel output for speakers (not shown for the sake of graphic clarity) may also be enabled by the entertainment server 112. This may be accomplished through the use of digital interconnect outputs, such as Sony-Philips Digital Interface Format (SPDIF) or Toslink enabling the delivery of Dolby Digital, Digital theater Sound (DTS), or Pulse Code Modulation (PCM) surround decoding.

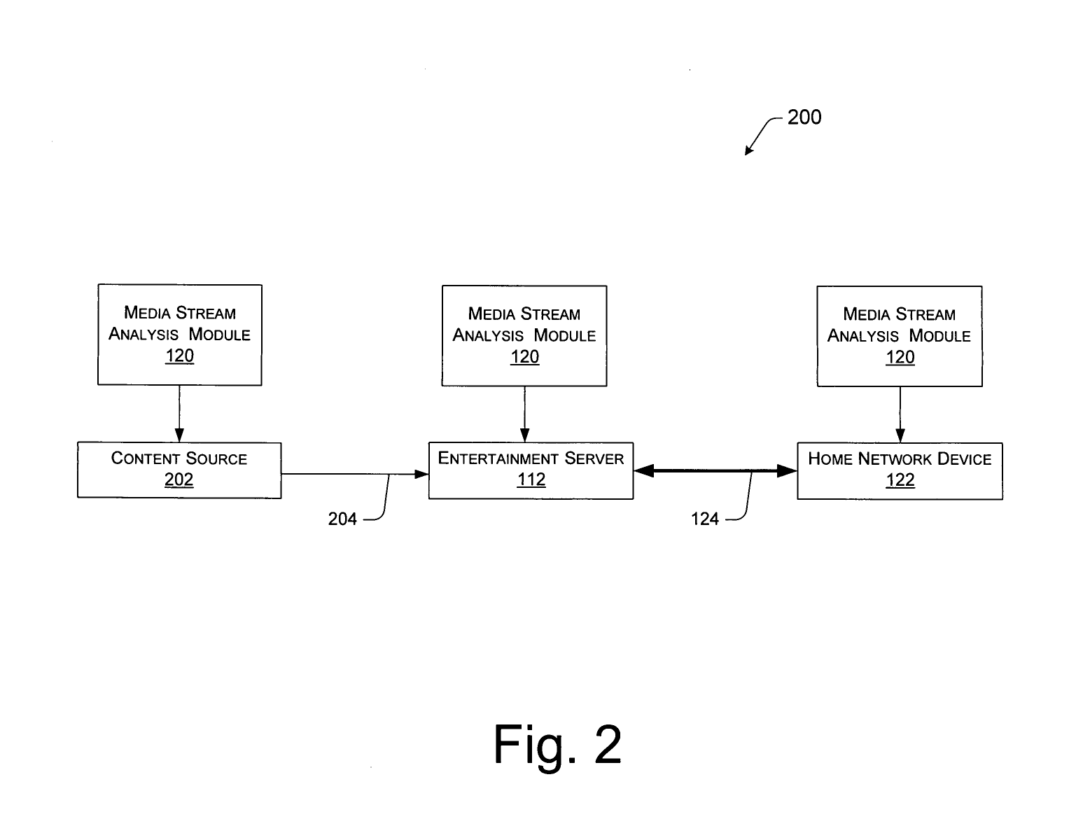

Additionally, the entertainment server 112 may include a media stream analysis module 120 configured to detect and correct any defects or errors in media content delivered through the entertainment server 112. It will be understood that the terms “defect” and “error” include variations in the media content from an encoding specification for a media format being employed by the media content. The media stream analysis module 120 detects and corrects errors and defects in media content by such acts as the insertion, deletion and correction of headers in samples of the media content, the throttling of audio content versus video content in the media content, the insertion of broken link flags into the media content, and the dropping of samples from the media content. The media stream analysis module 120, and methods involving its use, will be described in more detail below in conjunction with FIGS. 2-6.

Since the entertainment server 112 may be a full function computer running an operating system, the user may also have the option of running standard computer programs (word processing, spreadsheets, etc.), sending and receiving emails, browsing the Internet, or performing other common functions.

The home environment 100 may also include a home network device 122 placed in communication with the entertainment server 112 through a network 124. Home network device 122 may include Media Center Extender devices marketed by the Microsoft Corporation, Windows® Media Connect devices, game consoles, such as the Xbox game console marketed by the Microsoft Corporation, and devices which enable the entertainment server 112 to stream audio and/or video content to a monitor 106, 108, 110 or an audio system. The home network device 122 may also be implemented as any of a variety of conventional computing devices, including, for example, a desktop PC, a notebook or portable computer, a workstation, a mainframe computer, an Internet appliance, a gaming console, a handheld PC, a cellular telephone or other wireless communications device, a personal digital assistant (PDA), a set-top box, a television, an audio tuner, combinations thereof, and so on.

The network 124 may comprise a wired, and/or wireless network, or any other electronic coupling means, including the Internet. It will be understood that the network 124 may enable communication between the home network device 122 and the entertainment server 112 through packet-based communication protocols, such as transmission control protocol (TCP), Internet protocol (IP), real time transport protocol (RTP), and real time transport control protocol (RTCP). The home network device 122 may also be coupled to the secondary TV 108 through wireless means or conventional cables.

The home network device 122 may be configured to receive a user experience stream (i.e. the system/application user interface, which may include graphics, buttons, controls and text) as well as a compressed, digital audio/video stream from the entertainment server 112. The user experience stream may be delivered in a variety of ways, including, for example, standard remote desktop protocol (RDP), graphics device interface (GDI), or hyper text markup language (HTML). The digital audio/video stream may comprise video IP, SD, and HD content, including video, audio and image files, decoded on the home network device 122 and then “mixed” with the user experience stream for output on the secondary TV 108. Media content may be delivered to the home network device 122 in formats such as MPEG-1, MPEG-2, MPEG-4 and Windows Media Video (WMV).

In FIG. 1, only a single home network device 122 is shown. It will be understood, however, that a plurality of home network devices 122 and corresponding displays may be dispersed throughout the home environment 100, communicatively coupled to the entertainment server 112. It will also be understood that in addition to the home network device(s) 122 and the monitors 106, 108, 110, the entertainment server 112 may be communicatively coupled to other output peripheral devices, including components such as a printer (not shown for the sake of graphic clarity).

### System With Media Stream Analysis Module

FIG. 2 shows an exemplary architecture of a media delivery system 200 suitable for delivering media content from a content source 202 via the entertainment server 112 to the home network device 122. The content source 202 may include removable/non-removable and volatile/non-volatile computer storage media. For example, the content source 202 could include non-removable, non-volatile magnetic media such as a hard disk; removable, non-volatile magnetic media such as a floppy disk; and a removable, non-volatile optical disk such as a CD-ROM, DVD-ROM, or other optical media. All of the above examples may reside on, or be introducible to, the entertainment server 112. In which case, a coupling 204 between the content source 202 and the entertainment server 112 could be a system bus within the entertainment server 112.

Alternately, the content source 202 could be a remote storage medium or broadcasting entity apart from the entertainment server 112. In such case, the coupling 204 could include the cable 114, the satellite 116, an antenna, and/or a network such as the Internet 118. It is also possible that that the content source 202 could include devices, such as digital cameras or video cameras, coupled directly to the entertainment 112. In such a case, the coupling 204 could include a wired or wireless coupling.

As shown in FIG. 2, the media stream analysis module 120 may reside at several locations in the media delivery system 200. Moreover, the media delivery system 200 may employ several media stream analysis modules 120 at various locations simultaneously. In general, the media stream analysis module 120 may reside, or induce its functionality, at any point in the media delivery system 200 before the media content reaches a decoder which will render the media content.

In perhaps its simplest implementation, the media stream analysis module 120 may reside at the entertainment server 112. In this configuration, the media stream analysis module 120 may be used to detect and correct errors and defects in media content before the media content is streamed by the entertainment server 112 to the home network device 122 over network 124.

It is also possible, however, for the media stream analysis module 120 to reside outside of the entertainment server 112. In one exemplary implementation, the media stream analysis module 120 may reside at the content source 202. In such a configuration, the media stream analysis module 120 may be used to detect and correct errors and defects in media content before the media content is delivered over the coupling 204.

In general, the media stream analysis module 120 corrects the media content such that: (1) the media content is placed in compliance with one or more media delivery format specifications (such as the Digital Living Network Alliance (DLNA) standards) or encoding specifications, in order to avoid any problems which might occur as a result of poor defect or error handling by a decoder in the home network device 122; (2) unnecessary portions of the media content are removed, thus decreasing resources needed to deliver and render the media content; and (3) skew between audio content and video content (A/V skew) in the media content is reduced or eliminated, thus synchronizing the audio and video content.

In such an instance where the correction performed by the media stream analysis module 120 requires the dropping of portions of the media content, the corrected stream may enjoy a lower bit rate, thus resulting in a decrease in the amount of media delivery resources required to transmit the media content from the content source 202 to the home network device 122. It will be understood that the term “media delivery resources” includes resources of the coupling 204 and the network 124, as well as resources of the home network device 122 and the entertainment server 112 (including memory resources, bus resources, decoder resources, buffer resources, I/O interface resources, and CPU and GPU resources).

In another exemplary implementation, the media stream analysis module 120 may reside between the content source 202 and the entertainment server 112—such as on an access point. In such a position, the media stream analysis module 120 could deliver a corrected stream of media content over the coupling 204 to the entertainment server 112. As a result, the media stream analysis module 120 could potentially decrease the amount of media content being handled by the resources of the coupling 204 and the network 124. In addition, the corrected stream may be less burdensome on the resources of the entertainment server 112 and the home network device 122 (such as memory resources, bus resources, decoder resources, buffer resources, I/O interface resources, and CPU and GPU resources on the entertainment server 112 and the home network device 122).

In another exemplary embodiment, the media stream analysis module 120 may reside between the entertainment server 112 and the home network device 122—such as on an access point. In such a configuration, the media stream analysis module 120 could be used to deliver a corrected stream of media content over the network 124 between the entertainment server 112 and the home network device 122. In such a configuration the media stream analysis module 120 could potentially decrease the amount of media content being handled by the resources of the network 124 and the home network device 122 (such as memory resources, bus resources, decoder resources, buffer resources, I/O interface resources, and CPU and GPU resources on the home network device 122).

In yet another exemplary embodiment, the media stream analysis module 120 could reside on the home network device 122, itself. In such a configuration, the media stream analysis module 120 could correct error or defect containing media content before the media content is decoded by a decoder in the home network device 122. In the event that the correction process entails the dropping of portions of the media content, the corrected stream of media content could decrease the amount of resources used on the home network device 122 (i.e. the memory resources, the bus resources, the decoder resources, buffer resources, I/O interface resources, and the CPU and GPU resources of the home network device 122).

As mentioned above, it is also possible to use several media stream analysis modules 120 simultaneously. For example, one media stream analysis module 120 could be located on the content source 202 in order to correct defects and errors in the media content before the media content is delivered over the coupling 204 between the content source 202 and the entertainment server 112. Simultaneously, another media stream analysis module 120 residing on the entertainment server 112 could be used to correct defects and errors in the media content before the media content is delivered over the network 124 between the entertainment server 112 and the home network device 122.

In one possible implementation, the media stream analysis module 120 on the entertainment server 112 could be more sensitive that the media stream analysis module 120 on the content source 202. In such a configuration, the media stream analysis module 120 on the entertainment server 112 could correct errors and defects missed by the media stream analysis module 120 on the content source 202. In another possible implementation, the media stream analysis module 120 on the entertainment server 112 could have approximately the same sensitivity as the media stream analysis module 120 on the content source 202. In such a configuration the media stream analysis module 120 on the entertainment server 112 could correct any errors or defects added to the stream of media content as the media content is delivered from the content source 202 to the entertainment server 112.

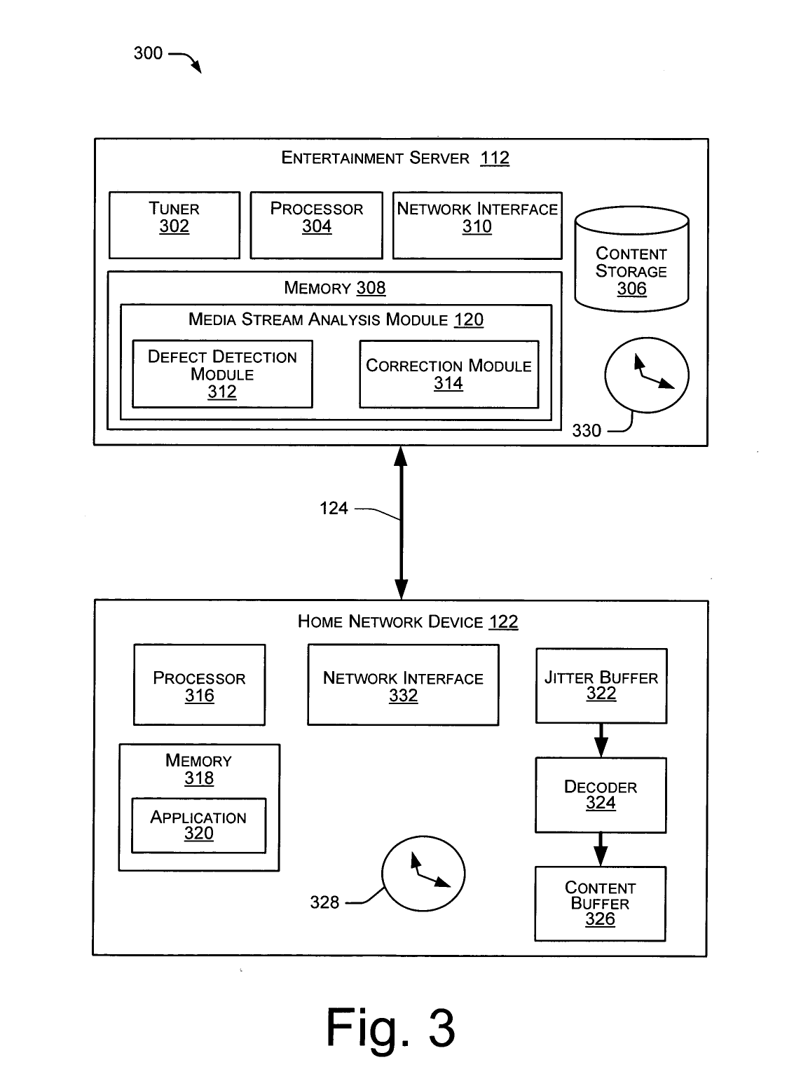

FIG. 3 shows an exemplary architecture 300 suitable for delivering media content to the home network device 122 from the entertainment server 112. In FIG. 3, the media stream analysis module 120 is illustrated as residing on the entertainment server 112. As noted above, however, it will be understood that the media stream analysis module 120 need not be hosted on the entertainment server 112. For example, the media stream analysis module 120 could also be hosted on the content source 202, the home network device 122, an access point, or any other electronic device or storage medium communicatively coupled to a path along which media content is conveyed on its way from the content source 202 to the home network device 122.

The entertainment server 112 may include one or more tuners 302, one or more processors 304, a content storage 306 (which may or may not be the same as the content source 202 in FIG. 2), memory 308, and one or more network interfaces 310. As noted above, the tuner(s) 302 may be configured to receive media content via sources such as an antenna, cable 114, satellite 116, the Internet 118, or a wired or wireless coupling. The media content may be received in digital form, or it may be received in analog form and converted to digital form at any of the one or more tuners 302 or by the one or more microprocessors 304 residing on the entertainment server 112. Media content either processed and/or received (from another source) may be stored in the content storage 306. FIG. 3 shows the content storage 306 as being separate from memory 308. It will be understood, however, that content storage 306 may also be part of memory 308.

The network interface(s) 310 may enable the entertainment server 112 to send and receive commands and media content among a multitude of devices communicatively coupled to the network 124. For example, in the event both the entertainment server 112 and the home network device 122 are connected to the network 124, the network interface 310 may be used to deliver content such as live HD television content from the entertainment server 112 over the network 124 to the home network device 122 in real-time with media transport functionality (i.e. the home network device 122 may render the media content and the user may be afforded functions such as pause, play, seek, fast forward, rewind, etc).

Requests from the home network device 122 for media content available on, or through, the entertainment server 112 may also be routed from the home network device 122 to the entertainment server 112 via network 124. In general, it will be understood that the network 124 is intended to represent any of a variety of conventional network topologies and types (including optical, wired and/or wireless networks), employing any of a variety of conventional network protocols (including public and/or proprietary protocols). As discussed above, network 124 may include, for example, a home network, a corporate network, the Internet, or IEEE 1394, as well as possibly at least portions of one or more local area networks (LANs) and/or wide area networks (WANs).

The entertainment server 112 can make any of a variety of data or content available for delivery to the home network device 122, including content such as audio, video, text, images, animation, and the like. In one implementation, this content may be streamed from the entertainment server 112 to the home network device 122. The terms “streamed” or “streaming” are used to indicate that the content is provided over the network 124 to the home network device 122 and that playback of the content can begin prior to the content being delivered in its entirety. The content may be publicly available or alternatively restricted (e.g., restricted to only certain users, available only if an appropriate fee is paid, and/or restricted to users having access to a particular network, etc.). Additionally, the content may be “on-demand” (e.g., pre-recorded, stored content of a known size) or alternatively it may include a live “broadcast” (e.g., having no known size, such as a digital representation of a concert being captured as the concert is performed and made available for streaming shortly after capture).

Memory 308 stores programs executed on the processor(s) 304 and data generated during their execution. Memory 308 may include volatile media, non-volatile media, removable media, and non-removable media. It will be understood that volatile memory may include computer-readable media such as random access memory (RAM), and non volatile memory may include read only memory (ROM). A basic input/output system (BIOS), containing the basic routines that help to transfer information between elements within the entertainment server 112, such as during start-up, may also be stored in ROM. RAM typically contains data and/or program modules that are immediately accessible to and/or presently operated on by the one or more processors 304.

As discussed above, the entertainment server 112 may also include other removable/non-removable, volatile/non-volatile computer storage media such as a hard disk drive for reading from and writing to a non-removable, non-volatile magnetic media, a magnetic disk drive for reading from and writing to a removable, non-volatile magnetic disk (e.g., a “floppy disk”), and an optical disk drive for reading from and/or writing to a removable, non-volatile optical disk such as a CD-ROM, DVD-ROM, or other optical media. The hard disk drive, magnetic disk drive, and optical disk drive may each be connected to a system bus (discussed more fully below) by one or more data media interfaces. Alternatively, the hard disk drive, magnetic disk drive, and optical disk drive may be connected to the system bus by one or more interfaces.

The disk drives and their associated computer-readable media provide non-volatile storage of media content, computer readable instructions, data structures, program modules, and other data for the entertainment server 112. In addition to including a hard disk, a removable magnetic disk, and a removable optical disk, as discussed above, the memory 308 may also include other types of computer-readable media, which may store data that is accessible by a computer, like magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the memory 308 including, by way of example, an operating system, one or more application programs, other program modules, and program data. One such application could be the media stream analysis module 120, which includes a error detection module 312, and a correction module 314.

The media stream analysis module 120 may be executed on processor(s) 304, and can be used to detect and correct errors and defects in media content during the streaming of media content from the entertainment server 112 to the home entertainment device 122. In addition to being implemented, for example, as a software module stored in memory 308, the media stream analysis module 120 may also reside, for example, in firmware. Moreover, even though the error detection module 312, and the correction module 314 are shown in FIG. 3 as residing inside the media stream analysis module 120, either or both of these elements may exist separate and as stand alone applications. Generally, however, both the error detection module 312 and the correction module 314 are placed before a decoder which receives and renders the media content. More discussion of the nature and function of the media stream analysis module 120 will be given below.

The entertainment server 112 may also include a system bus (not shown for the sake of graphic clarity) to communicatively couple the one or more tuners 302, the one or more processors 304, the network interface 310, and the memory 308 to one another. The system bus may include one or more of any of several types of bus structures, including a memory bus or memory controller, a peripheral bus, an accelerated graphics port, and a processor or local bus using any of a variety of bus architectures.

A user may enter commands and information into the entertainment server 112 via input devices such as a keyboard, pointing device (e.g., a “mouse”), microphone, joystick, game pad, satellite dish, serial port, scanner, and/or the like. These and other input devices may be connected to the one or more processors 304 via input/output (I/O) interfaces that are coupled to the system bus. Additionally, input devices may also be connected by other interface and bus structures, such as a parallel port, game port, universal serial bus (USB) or any other connection included in the network interface 310.

In a networked environment, program modules depicted and discussed above in conjunction with the entertainment server 112 or portions thereof, may be stored in a remote memory storage device. By way of example, remote application programs may reside on a memory device of a remote computer communicatively coupled to network 124. For purposes of illustration, application programs and other executable program components, such as the operating system and the media stream analysis module 120, may reside at various times in different storage components of the entertainment server 112, or of a remote computer, and may be executed by one of the at least one processors 304 of the entertainment server 112 or of the remote computer.

The exemplary home network device 122 may include one or more processors 316, and a memory 318. Memory 318 may include one or more applications 320 that consume or use media content received from sources such as the entertainment server 112. A jitter buffer 322 may receive and buffer data packets streamed to the home network device 122 from the entertainment server 112. Because of certain transmission issues including limited bandwidth and inconsistent streaming of content that lead to underflow and overflow situations, it is desirable to keep some content (i.e., data packets) in the jitter buffer 322 in order to avoid glitches or breaks in streamed content, particularly when audio/video content is being streamed.

In the implementation shown in FIG. 3, a decoder 324 may receive encoded data packets from the jitter buffer 322, and decode the data packets. In other implementations, a pre-decoder buffer (i.e., buffer placed before the decoder 324) may be incorporated. In certain cases, compressed data packets may be sent to and received by the home network device 122. For such cases, the home network device 122 may be implemented with a component that decompresses the data packets, where the component may or may not be part of decoder 324. Decompressed and decoded data packets may then be received and stored in a content buffer 326.

The content buffer 326 may also include one or more buffers to store specific types of content. For example, there could be a separate video buffer to store video content, and a separate audio buffer to store audio content. Furthermore, the jitter buffer 322 could include separate buffers to store audio and video content.

The home network device 122 may also include a clock 328 to differentiate between data packets based on unique time stamps included in each particular data packet. In other words, clock 328 may be used to play the data packets at the correct speed. In general, the data packets are played by sorting them based on time stamps that are included in the data packets and provided or issued by a clock 330 of the entertainment server 112.

A user may enter commands and information into the home network device 122 via input devices such as a remote control, keyboard, pointing device (e.g., a “mouse”), microphone, joystick, game pad, satellite dish, serial port, scanner, and/or the like. These and other input devices may be connected to the one or more processors 316 via input/output (I/O) interfaces that are coupled to a system bus. Additionally, input devices may also be connected by other interface and bus structures, such as a parallel port, game port, universal serial bus (USB) or any other connection included in a network interface 332.

### Operation of Media Stream Analysis Module

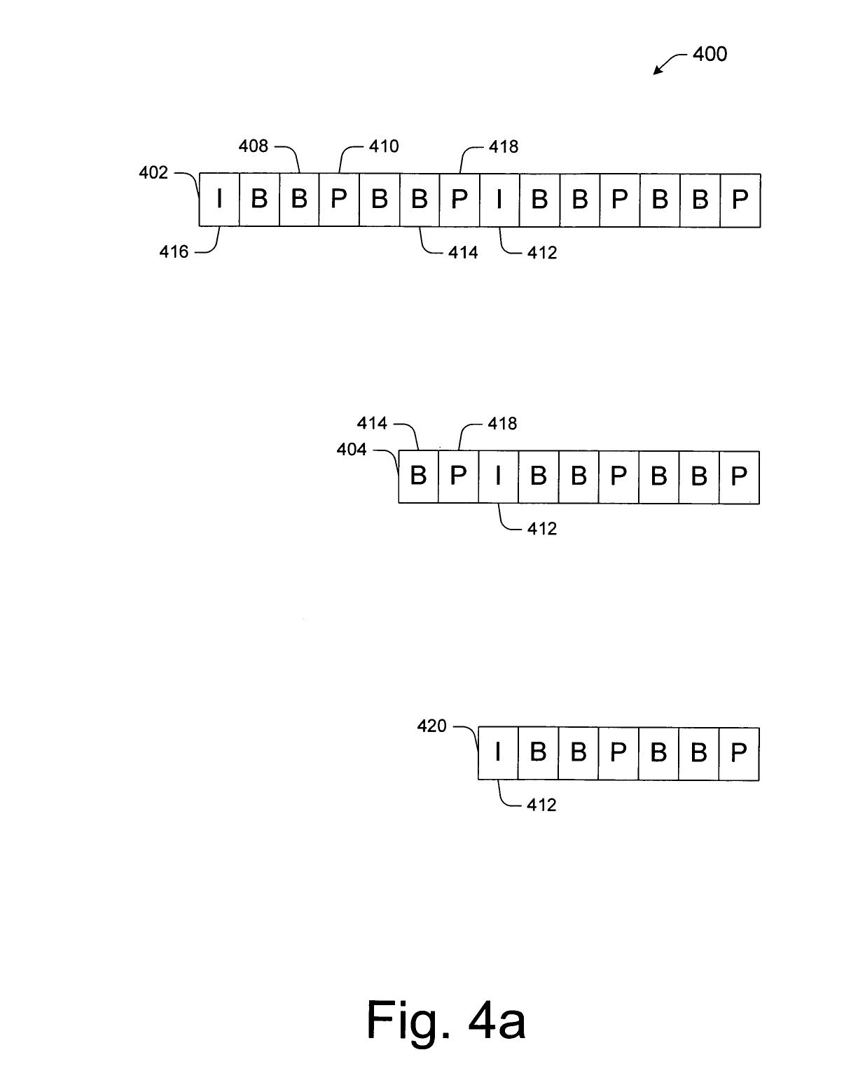

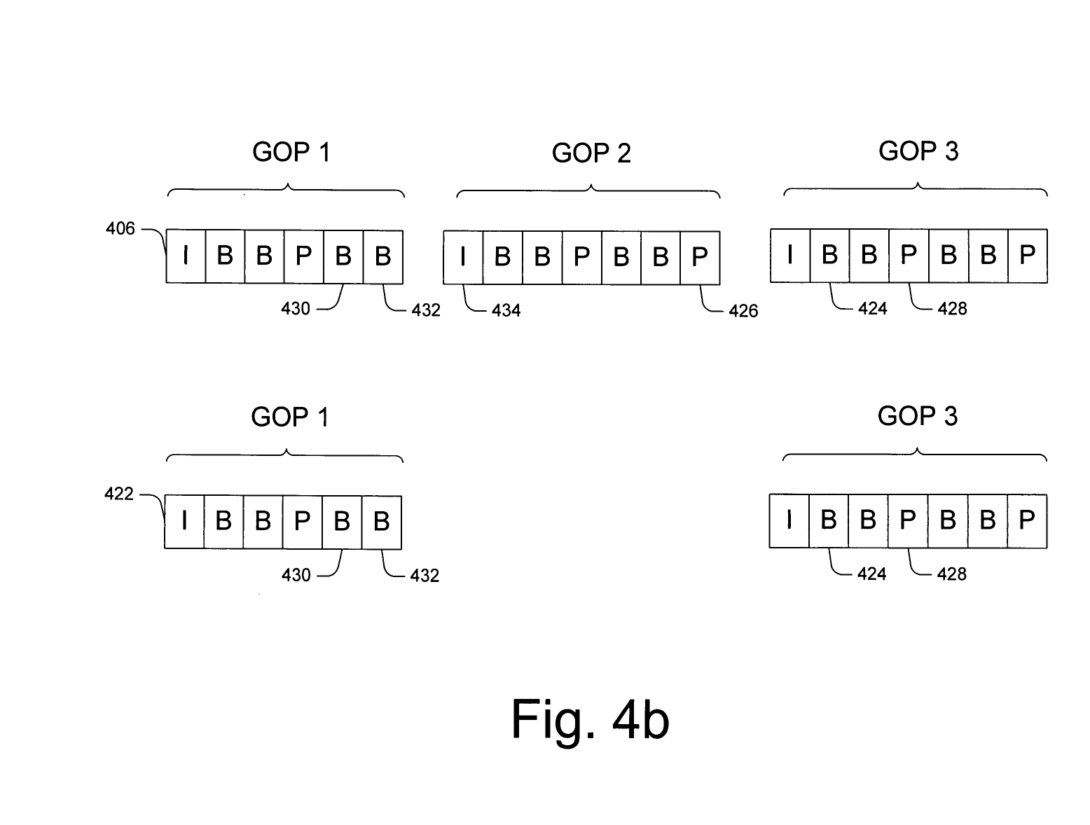

FIGS. 4a and 4b show a stream of frames 402 along with several examples of error or defect containing streams 404, 406 which may be encountered by the media stream analysis module 120 while media content is being streamed. In FIGS. 4a and 4b, the stream of frames 402 and the exemplary streams 404, 406 contain samples such as bi-directionally predicted B-frames 408, non bi-directionally predicted P-frames 410, and I-frames 412 as might be found in video formats like MPEG-1, MPEG-2, MPEG-4 and WMV It will be understood, however, that in addition to MPEG-1, MPEG-2, MPEG-4 and WMV formats, other formats—including non bi-directionally predicted formats—may also be used with the media stream analysis module 120. In addition, the use of B-frames, P-frames and I-frames in FIGS. 4a and 4b is for illustrative purposes only. It will be understood that the media stream analysis module 120 may be used with streams having delta frames other than B-frames and P-frames, and key frames other than I-frames.

In operation, in order to stream media content from the content source 202 to the home network device 122, a stream of frames 402 including media content information is delivered from the content source 202 to the home network device 122 via the entertainment server 112. The media content delivered from the content source 202 may be encoded poorly, or may be damaged during delivery from the content source 202 to the media stream analysis module 120. As a result, the media content may have portions containing errors or defects such that the media content does not conform to media delivery format specifications such as DLNA standards, or to various encoding standards consistent with a specification under which the stream of media content was encoded. Moreover, since decoders 324 of varying quality exist, any errors or defects in the media content may result in a degradation of user experience of varying degree when the decoder 324 attempts to decode the media content at the home network device 122.

Stream of frames 404 shown in FIG. 4a illustrates what could happen to stream 402 due to a discontinuity resulting from events such as network interruptions, encoder errors, startup, channel changes, and positional changes within a stream of media content caused by events such as fast forwarding, rewinding or seeking. As shown, stream 404 begins with a B-frame 414 instead of an I-frame such as frame 416 found at the beginning of stream 402. Many decoders 324 need a sync point such as an I-frame in order to begin—or resume—decoding a stream of media content. This is especially the case with lower quality, and less robust decoders 324.

Frames preceding an initial sync point may thus be meaningless to the decoder 324. For example, the P-frame 410, from which B-frame 414 derives some of its content, is not included within stream 404. Thus all of the information needed to decode B-frame 414 is not available to the decoder 324, and as a result B-frame 414 may not be renderable by the decoder 324. Moreover, P-frame 418—which also depends on P-frame 410 for content—may be equally useless to the decoder 324. Correspondingly, it is possible that neither B-frame 414 nor P-frame 418 can be used by decoder 324 for the purpose of rendering a high quality user experience.

For these reasons, once the discontinuity in stream 404 is located by the error detection module 312, the correction module 314 may be employed to drop frames 414, 418 in order to create a corrected stream 420. As shown, the corrected stream 420 begins at a natural sync point—I frame 412—which will allow the decoder 324 to easily begin decoding the stream 420, thus maximizing the quality of the possible user experience afforded by the original stream of frames 404 received by the media stream analysis module 120. In addition, by dropping frames 414, 418 the media stream analysis module 120 may decrease the bit rate of the media content which will continue downstream to the home network device 122. Such a decrease can help improve performance of the media delivery system shown in architecture 200 by lessening the load which will be transmitted and handled by the media delivery resources of architecture 200 following the media stream analysis module 120.

Another type of error or defect which can be encountered by the media stream analysis module 120 is illustrated in FIG. 4b by streams 406, 422. Stream 406 includes three distinct groups of pictures (GOPs)-GOP 1, GOP 2, and GOP 3. In stream 406, B-frame 424 from GOP 3 depends upon P-frame 426 from GOP 2; thus, GOP 3 is an open GOP, since B-frame 424 spans both GOP 2 and GOP 3. This results because in addition to depending on P-frame 428 in GOP 3 for content, B-frame 424 also depends on P-frame 426 in GOP 2 for content.

Stream 422 shows what stream 406 could look like after a discontinuity is introduced into stream 406 such that GOP 2 is not transmitted following GOP 1. In such a scenario, one of the frames on which B-frame 424 depends for content—P-frame 426 in GOP 2—is not present. Thus, B-frame 424 may not be renderable by the decoder 324.

The error detection module 312 may detect this discontinuity before the open GOP 3 and signal the correction module 314 to insert a broken link flag into the stream 422 to properly signal the broken link at GOP 3 (i.e. the presence of a discontinuity preceding the open GOP 3) to the decoder 324. A broken link flag not only conforms to standards such as that promulgated by the DLNA, but it can also aid decoders 324 in decoding the stream 406 to ensure the highest possible quality of user experience renderable from stream 406. In one exemplary implementation, the broken link flag may be placed on GOP 3, such as in the GOP header of GOP 3. It is also possible, however, to place the broken link flag in other locations—or in other headers—in order to comply with the various media delivery format specifications or encoding specifications which might be appropriate.

For media formats that support B-frames that span GOPs into the future (e.g. in exemplary stream 406, B-frames 430, 432 of GOP 1 are dependent upon I-frame 434 from GOP 2), the media stream analysis module 120 may also drop the trailing B-frames 430, 432 of GOP 1 in stream 422. The media stream analysis module 120 may do this because of the absence of I-frame 434 on which B-frames 430, 432 depend for some of their content. This absence of I-frame 434 may prevent the decoder 324 from accessing all of the information needed to produce a quality rendering of B-frames 430, 432.

By dropping B-frames 430, 432, and/or 424, the media stream analysis module 120 may decrease the bit rate of the stream 422. This, in turn, can help to improve the performance of the media delivery system shown in architecture 200 by lessening the load to be transmitted and handled by the media delivery resources of architecture 200 downstream of the media stream analysis module 120.

Another error or defect which may be found in a stream of media content is that of stream compliance issues. Stream compliance issues arise when media content lacks adequate headers, such as, for example sequence headers telling the decoder 324 how quickly to render the media content in frames per second. This absence of adequate headers can be caused by a variety of factors—including the dropping of frames discussed above in regard to the correction of discontinuities in streams 404, 406. Media content may also have inadequate headers due to, for example, bad encoding of media content, the erroneous dropping or corruption of portions of media content by the media delivery resources of architecture 200, and the need to comply with various media content streaming standards.

For example, MPEG-1 files may be encoded with only a single sequence header. Thus, when a discontinuity in a stream of media content is encountered, the decoder 324 may lose its reference to the sequence header in the media content. This can result in glitches and/or failures in the rendering of the media content, resulting in a less than optimal user experience.

Thus, the media stream analysis module 120 may also be used to locate and correct media content with missing, incorrect or otherwise inadequate headers. For example, the error detection module 312 may examine all media content to make sure that proper headers exist. If any error or defect is found, the error detection module 312 can direct the correction module 314 to either place a correct header on a frame which is missing a header, or otherwise insert or repair existing headers to bring the media content into compliance with various appropriate standards in order to avoid compliance issues or errors in decoding at the decoder 324. The end result of the correction module 314 will be a stream of media content having a proper amount of headers according to whichever encoding or delivery standards are applicable. Moreover, the headers of media content corrected at the correction module will be in a proper form to allow the decoder 324 to easily decode the media content. The result-will be an increase in the quality of user experience which can be attained from the stream of media content.

In the MPEG-1 example mentioned above, following a discontinuity, the media stream analysis module 120 may insert a proper sequence header on the first sync point after the discontinuity. This sequence header may be copied from the last cached sequence header.

It will also be understood that the correction module 314 may perform multiple tasks when correcting media content. For example, when the correction module 314 addresses discontinuities in the stream of media content as discussed in conjunction with streams 404 and 406 above, in addition to dropping frames and placing broken link flags into streams of corrected media content, the correction module 314 may also add various headers to frames which might not have headers but which might need them. Moreover, the correction module 314 may also correct or delete headers when needed.

Another possible defect which may be found in a stream of media content is that of audio/video (A/V) skew. A/V skew is a condition in which audio and video information arrive at the decoder 324 at varying rates, or in which audio content arrives out of sync from video content as measured by comparing the time at which the audio and video samples are to be presented. For example, encrypted media content received at the entertainment center 112 from the content source 202 may need to be decrypted before being streamed to the home network device 122. If video content takes more time to be decrypted than audio content, then the audio content may arrive at the decoder 324 before the corresponding video content. In such a scenario, a buffer—such as the jitter buffer 322—may be needed at the home network device 122 in order to buffer the audio content until the corresponding video content arrives. In some instances, the buffer may be too small to perform such a function or may already be full with content as it tries to perform its primary function (in the case of the jitter buffer 322, its primary function would be the buffering of enough content to protect against glitches or breaks in streamed media content).

Aside from encryption/decryption issues, A/V skew may also result from other factors, such as various processing and transmission delays throughout architecture 200, as well as pre-existing A/V skew in media content delivered from the content source 202.

When media content exhibiting A/V skew is encounter by the media stream analysis module 120, the A/V skew may be detected by the error detection module 312. The error detection module 312 may then instruct the correction module 314 to begin throttling the audio content and video content relative to each other in order to produce corrected media content. Corrected media content is media content in which little or no skew exists between the audio content and the video content.

For example, in the case mentioned above, if A/V skew is created by differential decryption times, the error detection module 312 may detect the A/V skew and instruct the correction module 314 to begin buffering the media content. The error detection module 312 may also determine which of the video content or the audio content is being decrypted more quickly by examining time stamps placed on the audio and video content by clocks, such as clock 330. If the error detection module 312 determines that the audio content is arriving before the correspondingly time-stamped video content, then the media stream analysis module 120 may begin buffering the audio content. In this way the audio content may be held until its corresponding video content arrives. When the video content corresponding to the first saved audio content arrives, and properly synchronized media content can be assembled, the audio content and its corresponding video content may be properly matched on the basis of the time stamps in both the audio and video content, and the synchronized media content may be sent downstream in the architecture 200 towards the decoder 324.

It will also be understood that in some instances the video content may arrive at the media stream analysis module 120 before its proper accompanying audio content. In such a case, the video content may be buffered by the media stream analysis module 120 until the audio content corresponding to the video content arrives. Then, similar to above, the audio and video content may be properly matched on the basis of the time stamps in both the audio and video content, and the synchronized media content may be sent downstream in the architecture 200 towards the decoder 324.

In the instance that the media stream analysis module 120 resides on the entertainment server 112, or has ready access to a large buffer, the appropriate video or audio content may be buffered for a considerable time. This can help the decoder 324 by freeing up its buffering resources to perform their normal duties. Also, by presenting a stream of media content with little or no A/V skew to the decoder 324, the media stream analysis module 120 can increase the quality of the user experience which may be rendered from the media content through use of the decoder 324.

It will be understood that discontinuities, discontinuities preceding or following open GOPs, stream compliance issues and A/V skew represent only a sampling of the various errors and defects which may be detected and corrected by the media stream analysis module 120. In general, the media stream analysis module 120 may be employed to detect and correct any errors or defects in a stream of media content which might otherwise result in decoding or rendering errors at the decoder 324.

### Media Stream Analysis Method

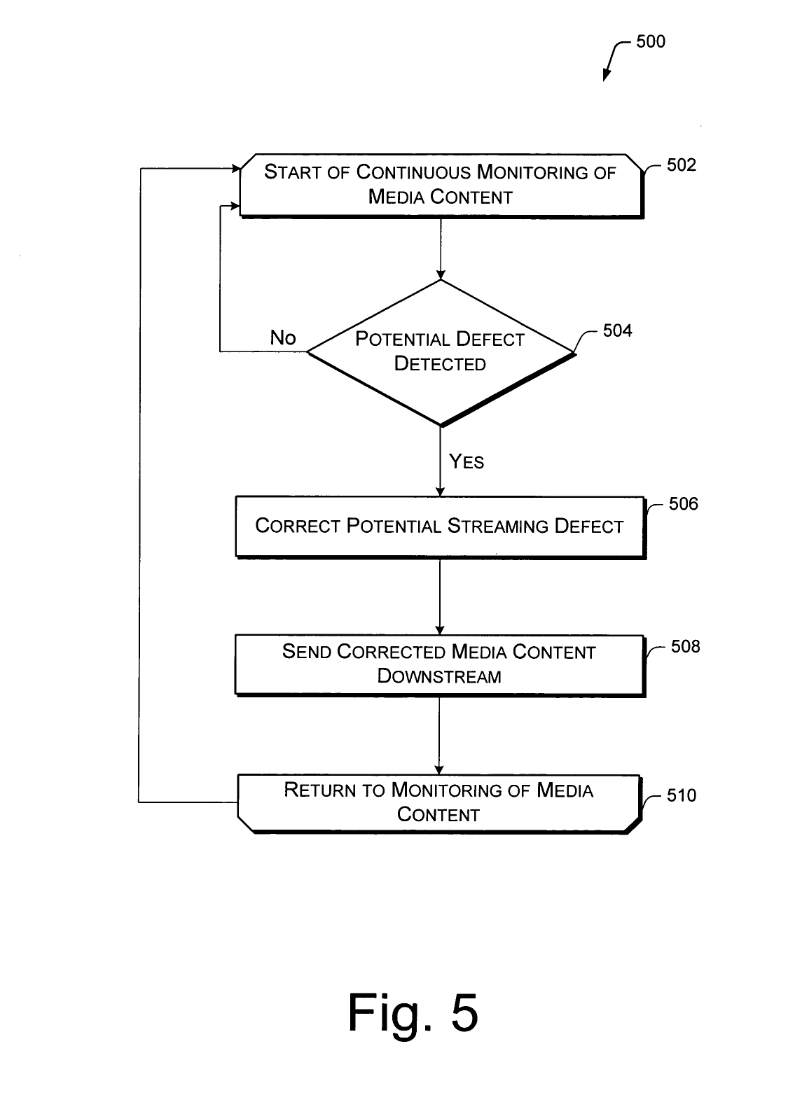

Another aspect of detecting and correcting errors and defects in media content being delivered from a content source 202 to a home network device 122 is shown in FIG. 5 which illustrates an exemplary method 500 performed by the media stream analysis module 120. For ease of understanding, the method 500 is delineated as separate steps represented as independent blocks in FIG. 5; however, these separately delineated steps should not be construed as necessarily order dependent in their performance. Additionally, for discussion purposes, the method 500 is described with reference to elements in FIGS. 1-4.

The method 500 may continuously monitor a stream of samples of media content at a block 502. Bi-directionally predicted formats—such as MPEG-1, MPEG-2, MPEG-4 and WMV formats—along with other non bi-directionally predicted formats may be monitored. The monitoring may be accomplished by continuously reviewing the stream of media content for errors and defects as the media content is streamed from a content source 202 to a home network device 122 (block 504).

Defects and errors which may be sought include discontinuities in the media stream, A/V skew in the media stream, and stream compliance issues. Such errors and defects may result from a variety of reasons. For example, the media content delivered from the content source 202 may be encoded poorly, or may be damaged somewhere in architecture 200. As a result, the media content may contain defective portions which do not conform to DLNA or other standards consistent with a media delivery format specification under which the stream of media content was encoded. Moreover, errors and defects in the media content may result from events such as network interruptions, encoder errors, startup, channel changes, and positional changes within a stream of media content caused by events such as fast forwarding, rewinding and seeking. Since decoders 324 of varying quality exist, any errors or defects in the media content may result in a degradation of user experience of varying degree when the decoder 324 attempts to decode the media content at the home network device 122.

If no defects or errors are detected in the stream of media content, then no intervention is necessary, and the method 500 returns to block 502 (i.e. the “no” branch from block 504).

Alternately, however, if a error or defect is detected in the stream of media content, (i.e. the “yes” branch from block 504), the method 500 may take action to correct the error or defect in the media content (block 506). One possible action may include the dropping of frames before or after a discontinuity. In particular, frames which may not be renderable by a decoder 324 may be dropped. Additionally, frames at the start of a sequence of frames 402 which are not key frames, such as I-frames, may also be dropped such that the decoder 324 may start at a sync point. By dropping frames, the burden placed on the media delivery resources of the architecture 200 downstream of where the correction is made may be lightened, thus improving the performance of the downstream media delivery resources of the architecture 200.

Another action which might be taken is the addition of missing headers, the removal of unneeded headers, and/or the correction of existing headers in the media content in order to enable a decoder 324 to avoid decoding errors while decoding the media content. Adding, deleting and/or correcting headers may also be used to place the media content into conformance with whichever media delivery or encoding specifications are appropriate for the stream of media content.

Yet another possible action includes the placement of a broken link flag into a stream of media content containing an open GOP preceded or followed by a discontinuity. Such a broken link flag may help to bring the stream of media content into conformance with standards such as that promulgated by the DLNA, and can also aid the decoder 324 in decoding the stream to ensure the highest possible quality of user experience renderable from the stream of media content. Additionally, unrenderable frames, or frames which cannot be rendered with great quality in the open GOP, may be dropped.

Another possible action which may be pursued includes the insertion, deletion or correction of headers in the media content. This may be done to ameliorate stream compliance issues and vitiate the possibility of the decoder 324 experiencing an error in decoding the media content. For example, the method 500 may insert a sequence header onto the first sync point after a discontinuity to prevent the decoder 324 from losing its reference to the media content being decoded. The end result will be a stream of media content having a proper amount of headers according to whichever delivery or encoding standards are applicable. Moreover, the headers of the corrected media content will be in a proper form to allow the decoder 324 to more easily decode the media content. The result will be an increase in the quality of user experience which can be attained from the stream of media content.

Still another possible action which may be pursued includes the throttling of audio and video content relative to one another to reduce or eliminate audio/video (A/V) skew. For example if the audio content is arriving before correspondingly time-stamped video content, then the audio content may be buffered until its corresponding video content arrives. The audio content and its corresponding video content may then be properly synchronized on the basis of the time stamps in both the audio and video content.

It will also be understood that multiple actions may be performed on the media content. For example, when discontinuities in the stream of media content are addressed with the dropping of frames, broken link flags may be placed into streams containing open GOPs adjacent to discontinuities, and various headers may be corrected, dropped or added to the media content as necessary to satisfy compliance issues and enable decoders 324 to more easily decode the media content.

Once the defects and errors in the media content detected at block 504 are corrected at block 506, the corrected media content may be released to the architecture 200 where it may subsequently be delivered to the decoder 324 in the home network device 122 (block 508). The method 500 may then return to block 502 and resume continuously monitoring the stream of media content for errors and defects (block 510).

It will be understood that discontinuities, discontinuities preceding or following open GOPs, stream compliance issues and A/V skew represent only a sampling of the various errors and defects which may be detected and corrected by the method 500. In general, the method 500 may be employed to detect and correct any errors or defects in a stream of media content which might otherwise result in decoding or rendering errors at the decoder 324.

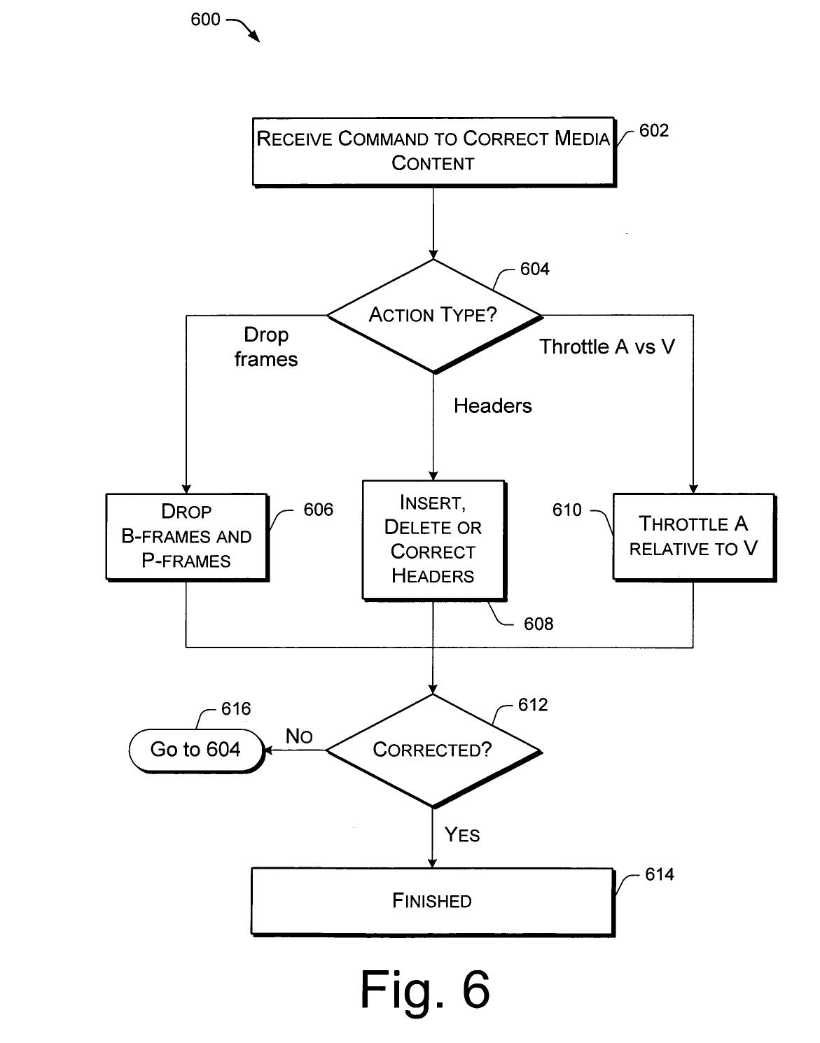

Another aspect of determining a desired action to correct an error or defect in a stream of media content is shown in FIG. 6, which illustrates an exemplary method 600 which may be performed by the correction module 314. For ease of understanding, the method 600 is delineated as separate steps represented as independent blocks in FIG. 6; however, these separately delineated steps should not be construed as necessarily order dependent in their performance. Additionally, for discussion purposes, the method 600 is described with reference to elements in FIGS. 1-4.

Moreover, as with method 500 above, method 600 may be used with bi-directionally predicted formats—such as MPEG-1, MPEG-2, MPEG-4 and WMV formats—along with other non bi-directionally predicted formats. Also, it will be understood that the use of B-frames, P-frames and I-frames in the explanation of FIG. 6 is for illustrative purposes only. Both the method 600 and the correction module 314 may be used with streams having delta frames other than B-frames and P-frames, and key frames other than I-frames.

Once an error or defect has been detected in the stream of media content, a command may be issued to take an appropriate action to cure the defect or error. When this command is received (block 602) the method 600 may pursue several actions to cure the defect or error (block 604).

One possible action includes the dropping of samples from the media content (i.e. the “Drop frames” branch from block 604). For example, in the event that the stream of media content contains a discontinuity resulting from events such as network interruptions, encoder errors, startup, channel changes, and positional changes within a stream of media content caused by events such as fast forwarding, rewinding or seeking, frames can be dropped from the media content following the discontinuity (block 606). This can be done since many decoders 324 need a sync point such as an I-frame in order to begin—or resume—decoding a stream of media content. Such is especially the case with lower quality, and less robust decoders 324.

Moreover, frames preceding an initial sync point may be meaningless. For example, if the first frame following a discontinuity is a B-frame, this B-frame will have no previous reference and thus will not be able to be decoded accurately by the decoder 324. Moreover, any B-frame or P-frame following this B-frame will not be able to be decoded correctly as it will lack the requisite preceding frame for reference. Thus all of the B-frames and P-frames following a discontinuity may be dropped until an I-frame, or sync point, is reached.

Dropping all of the B-frames and P-frames preceding the I-frame creates a corrected stream of media content which enables the decoder 324 to easily decode the corrected stream of media content by beginning at a sync point. In addition, by dropping the B-frames and P-frames following the discontinuity and preceding the next accessible I-frame, the method 600 decreases the bit rate of the media content which will continue on through the architecture 200 to the decoder 324 in the home network device 122. Such a decrease can help improve performance of the media delivery system shown in architecture 200 by lessening the load which will be transmitted and handled by the downstream media delivery resources of architecture 200.

Frame dropping may also be an appropriate course of action when, for example, one or more frames have been dropped from the media content, or corrupted, resulting in a discontinuity preceding or following an open GOP. In response to a discontinuity adjacent to an open GOP, a broken link flag may be inserted into the stream of media content. Such a broken link flag aids the decoder 324 in decoding the stream of media content, thus helping to ensure that the highest possible quality of user experience renderable from the stream of media content is attained by the decoder 324. In addition, the broken link flag also conforms to standards such as that promulgated by the DLNA. In one exemplary implementation, the broken link flag may be placed on the next GOP following the discontinuity, such as in the GOP header of the next GOP following the discontinuity. It is also possible, however, to place the broken link flag in other locations—or in other headers—in order to comply with the various media delivery format specifications or encoding specifications which might be appropriate.

In one possible implementation, one or more B-frames in an open GOP which span a discontinuity between the open GOP and a previous GOP may be dropped since the hanging B-frames may lack reference to a preceding frame (which has been dropped or corrupted) from which they draw some of their content.

In another possible implementation, one or more B-frames in an open GOP which span a discontinuity between the open GOP and a successive GOP may be dropped if the hanging B-frames lack reference to a succeeding frame (which has been dropped or corrupted) from which they draw some of their content.

Another possible action which can be taken to cure a defect or error in the stream of media content includes inserting, deleting or correcting various headers in the media content (i.e. the “Headers” branch from block 604). The insertion, deletion, or correction of headers in media content may be done to address stream compliance issues (block 608). Stream compliance issues arise when media content lacks adequate headers, such as sequence headers telling the decoder 324 how quickly to render the media content in frames per second. This absence of adequate headers can be caused by a variety of factors—including the dropping of frames discussed above in regard to the correction of discontinuities in streams (block 606). Media content may also have inadequate headers due to, for example, bad encoding of media content, and the erroneous dropping or corruption of portions of the media content by the architecture 200.

For example, in media content encoded in the MPEG-1 format, files may only have a single sequence header. Thus, when a discontinuity in a stream of media content is encountered, the decoder 324 may lose its reference to the sequence header in the media content. This can result in glitches and/or failures in the rendering of the media content, resulting in a less than optimal user experience.

Thus, if such a defect or error exists in the stream of media content the method 600 may place a correct sequence header on the first sync point following the discontinuity and otherwise insert, remove or correct various headers in the media content to bring the media content into compliance with various appropriate streaming and encoding standards to avoid compliance issues. The end result will be a stream of media content having a proper amount of headers according to whichever delivery or encoding standards are applicable. Moreover, the headers of the corrected media content will be in a proper form to allow the decoder 324 to more easily decode the media content without committing errors detrimental to the playability of the media content. The result will be an increase in the quality of user experience which can be attained from the stream of media content.

Yet another possible plan of action which may be pursued in correcting a defect or error in the media content includes the action of throttling the audio content in the media content relative to the video content in the media content (i.e. the “Throttle A vs V” branch from block 604). Under such a plan of action one of the audio content and the video content is buffered in order to allow the other component to catch up in order to decrease or eliminate A/V skew in the media content (block 610). For example if the audio content in the media content is arriving before correspondingly time-stamped video content in the media content, then method 600 may buffer the audio content and hold the audio content until its corresponding video content arrives. When this finally happens, the audio content and its corresponding video content may be properly matched on the basis of the time stamps in both the audio and video content, and the synchronized media content may be sent downstream in the architecture 200 towards the decoder 324.

It will also be understood that in some instances the video content may arrive before its proper accompanying audio content. In such a case, the video content may be buffered until the audio content corresponding to the video content arrives. Then, similar to above, the audio and video content may be properly matched on the basis of the time stamps in both the audio and video content, and the synchronized media content may be sent downstream in the architecture 200 towards the decoder 324.

In the instance that the media stream analysis module 120 resides on the entertainment server 112, or has ready access to a large buffer, the appropriate video or audio content may be buffered for a considerable time. This can help the decoder 324 by freeing up its buffering resources to perform their normal duties. Also, by presenting a stream of media content with little or no A/V skew to the decoder 324, the quality of the user experience which may be rendered from the media content through use of the decoder 324 may be increased.

Once the courses of action at blocks 606, 608, and 610 have been successfully pursued, the method 600 may then proceed to view the manipulated media content and confirm that all of the defects in the media content have been corrected (block 612). If no defects of errors are detected, then no further intervention is necessary (i.e. the “yes” branch from block 612), and the method 600 may finish and wait for another command to correct media content (block 614).

Alternately, if an error or defect is detected in the manipulated stream of media content, (i.e. the “no” branch from block 612), the method 600 may return to block 604 (block 616) and begin taking action to correct the error or defect in the media content.

For example, when a discontinuity is found in the stream of media content and B-frames and P-frames are dropped (block 606), the media content may incur stream compliance issues as the result of the dropped frames. In response, appropriate action may be taken by method 600 to insert, remove or correct headers in the media content (block 606) in order to bring the media content into compliance with various appropriate delivery or encoding standards and ameliorate any stream compliance issues. Moreover, the headers of the corrected media content will be in a proper form to allow the decoder 324 to easily decode the media content without resulting in quality compromising decoding errors which could adversely affect the playability of the media content.

Similarly, media content which has, for example, been manipulated at block 606 or block 608 may also have A/V skew. In such case, the method 600 may throttle the audio content and video content relative to one another until the A/V skew is eliminated and the media content is synchronized (block 610).

In this way, the method 600 may loop through the various courses of action 606, 608, 610 until all of the errors and defects in the media content are corrected. When no more errors can be detected, the method 600 may finally terminate (block 614) and await further commands to correct media content.

It will also be understood that in addition to the iterative approach discussed above, method 600 may also proceed in a more linear fashion. For example, the method 600 could first look to the error(s) detected and see if they require the dropping of frames (block 606). If such is the case, the appropriate frames could be dropped and the method 600 could continue on to see if the error(s) require the insertion, removal or correction of headers (block 608).

Alternately, if the errors require no dropping of frames, the method 600 could move directly to ascertaining if the error(s) require the insertion, removal or correction of headers (block 608).

Once the headers are corrected, or if the error(s) require no correction of headers, the method 600 could then ascertain if the error(s) require the throttling of the audio content and the video content relative to one another (block 610). After the skew is eliminated, or if no throttling is necessary, the method 600 could end (block 614). Of course, the order of actions presented above is only one exemplary implementation of method 600. The various actions (blocks 606, 608 610) could be placed in any desired order.

Moreover, in another possible exemplary implementation, in addition to the iterative and linear approaches discussed above, method 600 may also proceed in a more amorphous fashion. For example, if a series of errors or defects are detected in the media content, such as a discontinuity, a stream compliance issue, and A/V skew, the method 600 may employ actions (block 606, 608, 610) to correct all three defects simultaneously.

For example, in the event the media content has a discontinuity and AN skew, the method 600 may simultaneously buffer audio content relative to video content (block 610) while dropping appropriate B-frames and P-frames from the media content (block 606). The method 600 may also simultaneously, or subsequently, insert, delete or correct headers in the media content—as well as inserting broken link flags in the media content—to alleviate any stream compliance issues (block 608). In this way, the method 600 may completely correct all of the defects and errors in the stream of media content without having to return to the action blocks (606, 608, 610) by looping to block 604 from block 616.

It will be understood that discontinuities, discontinuities preceding or following open GOPs, stream compliance issues and AN skew represent only a sampling of the various errors and defects which may be corrected by the method 600. In general, method 600 may be employed to correct and cure any errors or defects in a stream of media content which might otherwise result in decoding or rendering errors at the decoder 324 and adversely affect the playability of the media content.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claimed invention.

1. A method, implementable by a computer system, comprising:
monitoring media content being streamed over a home network system;
detecting potential errors and defects in the media content;
correcting the potential errors and defects in the media content to produce a corrected media content; and
sending the corrected media content to a media decoder.

2. The method of claim 1, wherein said monitoring comprises reviewing the media content for at least one of variations from an encoding standard, variations from a media delivery format standard, discontinuities, Audio Video (A/V) skew, unusable portions, or unsignalled discontinuities wherein one or more frames necessary to decode one or more trailing bi-directionally predicted frames previous to the discontinuity are missing.

3. The method of claim 1, wherein said correcting comprises one of ensuring that the media content is in compliance with a specification, removing unuseable portions of the media content following a discontinuity in the media content, and throttling audio content and video content within the media content relative to one another.

4. The method of claim 3, wherein said ensuring comprises at least one of inserting at least one sequence header following a discontinuity in the media content, inserting at least one header to bring the media content into compliance with at least one of an encoding standard and a media delivery format standard, correcting at least one existing header to bring the media content into compliance with at least one of an encoding standard and a media delivery format standard, inserting at least one broken link flag into the media content to indicate the presence of a discontinuity adjacent to an open Group of Pictures (GOP) wherein one or more frames necessary to decode one or more bi-directionally predicted frames in the open GOP are missing, or dropping one or more bi-directionally predicted frames from an open GOP adjacent to a discontinuity wherein one or more frames necessary to decode the one or more bi-directionally predicted frames in the open GOP are missing.

5. The method of claim 3, wherein said removing comprises dropping all media samples in the media content between a discontinuity in the media content and a sync point in the media content.

6. The method of claim 3, wherein said throttling comprises buffering one of the audio content and the video content to eliminate skew in the media content.

7. The method of claim 1, wherein the media content is formatted according to at least one format from a group of formats comprising MPEG 1, MPEG 2, MPEG 4, and WMV.

8. A server intermediate of a source and a media playback device comprising:
a processor; and
a media stream analysis module executable on the processor to detect at least one of a possible error or defect in media content being delivered from the source to the media playback device and correct the at least one of a possible error or defect to produce corrected media content, and to send the corrected media content to the media playback device.

9. The server of claim 8, wherein the server is one of a home PC, an access point, and a set top box.

10. The server of claim 8, wherein the at least one of a possible error or defect comprises discontinuities in the media content, skew between audio content and video content within the media content, improperly signaled discontinuities adjacent to open Groups of Pictures (GOPs) in the media content, unsignalled discontinuities adjacent to open GOPs in the media content, and stream compliance issues in the media content.

11. The server of claim 10, wherein the stream compliance issues comprise corrupted files within the media content, missing headers within the media content, frames dropped from the media content, standards requirements absent from the media content, and discontinuities in the media content.

12. The server of claim 8, wherein the media stream analysis module resides in an operating system.

13. A computer-readable storage medium having computer-readable instructions that, when executed, perform acts comprising:
identifying at least one of a possible error or defect in media content being streamed from a source to a media playback device;
curing the at least one of a possible error or defect in the media content to improve a condition of playability of the media content and create corrected media content; and
delivering the corrected media content to the media playback device.

14. A media delivery system comprising at least one server utilizing the computer-readable instructions of claim 13 to facilitate the delivery of the media content having an improved playability to a decoder.

15. The computer-readable storage medium of claim 13, wherein said identifying comprises examining the media content for at least one of a missing header, a deficient header, a discontinuity, an improperly signaled discontinuity preceding an open Group of Pictures (GOP), an unsignalled discontinuity preceding an open GOP, skew between audio content and video content, a corrupted file, non compliance with a media encoding standard, or noncompliance with a media delivery format standard.

16. The computer-readable storage medium of claim 13, wherein said curing comprises dropping corrupted portions of the media content, adding missing headers to samples of the media content, dropping unnecessary headers from samples of the media content, amending headers on samples of the media content, inserting at least one broken link flag into the media content to indicate the presence of a discontinuity preceding an open Group of Pictures (GOP) wherein one or more frames necessary to decode one or more bi-directionally predicted frames in the open GOP are missing, dropping one or more bi-directionally predicted frames from an open GOP following a discontinuity wherein one or more frames which are necessary to decode the one or more bi-directionally predicted frames in the open GOP are missing, and buffering one of audio content and video content to eliminate skew between the audio and video content in the media content.

17. The computer-readable storage medium of claim 16, wherein said buffering occurs after the video content and the audio content have been decrypted.

18. The computer-readable storage medium of claim 13, wherein said curing comprises dropping all media samples after a discontinuity in the media content until a sync point is reached in the media content.

19. An operating system comprising the computer-readable instructions of claim 13.

20. An entertainment device comprising a processor and the computer readable storage medium of claim 13, wherein the computer-readable instructions are implemented on the processor.
